(19) United States
(12) Patent Application Publication
(10) Pub. No.: US 2024/0399385 A1
(43) Pub. Date: Dec. 5, 2024

(54) BLENDER SCREEN

(71) Applicants: Robert Hanshew, Fowler, IN (US); David J. Durrett, Dallas, TX (US)

(72) Inventors: Robert Hanshew, Fowler, IN (US); David J. Durrett, Dallas, TX (US)

(21) Appl. No.: 18/678,990

(22) Filed: May 30, 2024

Related U.S. Application Data
(60) Provisional application No. 63/505,648, filed on Jun. 1, 2023.

(51) Int. Cl. B03B 5/04; E21B 43/26

(52) U.S. Cl. CPC B03B 5/04; E21B 43/2607

(57) ABSTRACT

According to embodiments disclosed herein, there is provided a blender screen for filtering debris and unwanted objects from a granular material feed before the material is provided to a blender. The blender screen includes a screen frame having a first and second support wall, an internal support member, and a vibration device mount. The blender screen also includes a vibration device to provide vibration to the screen, increasing throughput of the granular material through the screen.

### CROSS-REFERENCE TO RELATED APPLICATIONS

This application claims the benefit under 35 U.S.C. 119 (e) of U.S. Provisional Patent Application No. 63/505,648 filed Jun. 1, 2023, the entire disclosure of which is hereby incorporated herein by reference for any purpose whatsoever.

### TECHNICAL FIELD

This disclosure relates to material screens for blenders for blending hydraulic fracturing fluid.

### BACKGROUND OF THE DISCLOSURE

Hydraulic fracturing, also known as “fracking,” is a technique used to extract natural gas or oil from underground shale formations. The process involves injecting a fracking fluid, a mixture of water, proppant, and chemicals, into a wellbore at high pressure to create tiny fractures in the rock. These fractures allow the gas or oil to escape from the rock and flow to the surface, where it can be captured and processed. The process of hydraulic fracturing involves several steps. First, a wellbore is drilled deep into the ground, typically several thousand feet below the surface. Once the wellbore has been drilled, a casing is inserted into the hole, and cement is used to seal the casing in place. Next, a perforating gun is lowered into the wellbore, and explosive charges are used to create small holes in the casing and cement to create communication between the wellbore and the formation. This allows fracking fluid to flow out of the wellbore and into the surrounding rock. Fracking fluid is injected into the wellbore at high pressure. The pressure of the fracking fluid causes the rock to fracture, creating tiny cracks and fissures that allow the gas or oil trapped in the formation to escape. The proppant in the fluid becomes wedged into the cracks and props them open even after the fluid pressure in the formation is reduced, resulting in more rapid production of hydrocarbons from the wellbore and greater overall utilization or capture of the hydrocarbons in the formation.

Blenders are specialized machines designed to combine the various components of the fracking fluid used during the fracking operation. A fracking fluid may typically include water, proppant, and chemicals, and the proportions of these components can vary depending on the specific characteristics of the formation being fractured. The blenders used in hydraulic fracturing operations are capable of handling large volumes of these components and mixing them to create a homogenous fluid that can be pumped into the wellbore. Most fracking fluid blenders include a mixing tank, a pump, and a control system. The mixing tank is where the water, sand, and chemicals are combined, and it is typically equipped with a series of mixing paddles or propellers that help to blend the components together.

A blender may be damaged by debris entering into the mixing tank. For this reason, the proppant feed must be carefully processed before being fed to the blender. Typically, sand is used as the proppant, and to avoid damage to the machinery, the proppant must be cleaned of debris and dried before it can be fed to the blender.

### SUMMARY

In a first aspect, a blender screen system is provided, the system including: a screen frame with an external frame having a first wall and an opposite second wall; an internal support beam extending from the first wall to the second wall; a first screen mount; a second screen mount; and a vibration device mount. The blender screen system includes a vibration device coupled with the vibration device mount and a screen having a first end and a second opposite end, wherein the first end of the screen is detachably coupled to the first screen mount and the second end of the screen is detachably coupled to the second screen mount, and wherein the first screen mount includes a tension adjustment portion configured to adjust the tension of the screen.

In some embodiments, the external screen frame also includes at least one support member extending from the external frame to support the screen on a support surface. In some embodiments, the at least one support member is configured to engage with at least one of a ground, a floor, a footer, a foot member, or a portion of the blender.

In some embodiments, the screen frame further comprises a second internal support beam extending from the first wall to the second wall. The internal support beams may all present the same height profile such that they support the screen in a relatively flat configuration. However, in some scenarios, it is advantageous for portions of the screen to be sloped. In such a situation, the internal support beams may be of varying heights such that they support the screen in a sloped configuration. In some embodiments, the first internal support beam supports the screen at a first elevation relative to a bottom surface of the screen frame and the second internal support beam supports the screen at a first elevation relative to the bottom surface of the screen frame, such that at least a portion of the screen is angled with respect to the bottom surface of the screen frame.

In some embodiments, the first end of the screen is detachably coupled to the first screen mount by at least one of a hook, a clasp, a screw, a bolt, a pin, or an adhesive. In some embodiments, the first screen mount comprises hooks configured to engage with a portion of the screen. In some embodiments, the screen comprises hooks configured to engage with at least one of the first screen mount and with the second screen mount.

In some embodiments, the vibration device is a vibrating motor. In some embodiments, the vibrating motor is adjustable to produce a desired amplitude and/or frequency of vibration. In some embodiments, the vibrating device is capable of producing a frequency of between about 1 Hz to about 1000 Hz.

In a second aspect, a method of providing material to a blender is provided herein, the method including at least the following steps: providing a screen adjacent a material inlet of the blender; vibrating at least a portion of the screen; directing a material flow into the inlet of the blender such that at least a portion of the material flow contacts the screen. In some embodiments, a majority of the material flow contacts the screen, and in other embodiments, substantially all of the material contacts the screen.

In some embodiments, the method also includes heating at least a portion of the screen. In some embodiments, the material flow provided is a wet sand. In some embodiments, the wet sand is at least partially dried by contacting the heated portions of the screen. In some embodiments, the method includes wetting the material flow prior to directing the material flow into the inlet of the blender. In some embodiments, the method includes washing the material flow prior to directing the material flow into the inlet of the blender.

In some embodiments, the material provided contains debris that is removed by the screen. In some embodiments, vibrating at least a portion of the screen comprises operating a vibrating motor coupled to the screen. In some embodiments, the method includes adjusting the tension of the screen.

### DESCRIPTION OF THE FIGURES

The accompanying drawings and photographs facilitate an understanding of the various embodiments.

FIG. 1 is an angled side view of a screen according to an embodiment.

FIG. 2A is an isometric view of a screen according to an embodiment including a vibration device.

FIG. 2B is an isometric view of a screen according to an embodiment including a vibration device.

FIG. 2C is an angled side view of a screen according to an embodiment including a vibration device.

FIG. 2D is a side view of a screen according to an embodiment including a vibration device.

FIG. 3 is a side view of a screen system according to an embodiment.

FIG. 4 is a flowchart illustrating a method of proving material to a blender according to an embodiment.

In the drawings, similar symbols typically identify similar components, unless context dictates otherwise. The illustrative implementations and embodiments described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Hydraulic fracturing is a common stimulation operation performed to increase production rate and overall productivity of hydrocarbon wells. During a fracking operation, fracking fluid is pumped into the producing formation at high pressure, causing portions of the formation to fracture. As the pressure on the formation is reduced, small proppant particles in the fracking fluid become trapped in the cracks and fissures formed in the formation. The proppant prevents the cracks and fissures from fully closing, providing openings or perforations through which the hydrocarbon material contained in the formation can flow.

The fracking fluid is typically mostly water, with granular or particulate proppant material suspended in the fluid. Other chemicals are added to the fracking fluid to reduce the surface tension of the fluid, to adjust the viscosity of the fluid, or to prevent the growth of microbes in the fluid during storage. The proportions of these components vary depending on the specific characteristics of the formation being fractured.

Proppant can vary in composition, size, and shape. The most commonly used proppant bases are sand, sintered bauxite (aluminum ore), and synthetic ceramics. Proppant bases may be coated with other materials to improve flow dynamics of the proppant within the wellbore and formation, or to improve performance of the proppant once deposited within the fractures. Proppant may be processed to produce particles that are spherical, cubic, or any other desired shape.

Sand is often used as a proppant due to being plentifully available, naturally sourced, and low cost. Sand particles have high compressive strength and are able to withstand the downhole pressures without being crushed. Sand may be sourced local to the wellbore where the hydraulic fracturing operation will take place, or may be sourced from remote locations.

Proppant is delivered in large quantities measuring several tons. As-delivered proppant includes contaminants such as stone or large aggregates, which can cause damage to the interior mechanisms of the blenders, resulting in costly downtime and equipment repairs. As such, the as-delivered proppant must be cleaned and screened to remove any objects that may cause damage to the blenders. This process can be very costly and time consuming.

Proppant is often washed or wetted to reduce the amount of dust that is generated as the proppant is transported, cleaned, or fed to the blender. Dust mitigation reduces foreign material being deposited near the wellbore site, and also reduces potential harm to workers at the site. However, wetted proppant is cohesive and also adheres to contaminants contained in the proppant, increasing the difficulty of removing all of the contaminants from the bulk proppant.

A system and method for the efficient and economical cleaning of bulk proppant is provided herein. A screen system is placed before the blender inlet that is capable of cleaning proppant at large throughputs. Alternatively, the screen system may be positioned before a proppant storage area or volume, such as a hopper, for storing the resulting cleaned proppant. Wet proppant can also be processed effectively by the present screen system and method. Through use of the screen system and the methods disclosed herein, it possible to process uncleaned, wet sand and other proppant at high rates of flow. This allows use of proppant sources that otherwise require costs and time-consuming cleaning and drying processes.

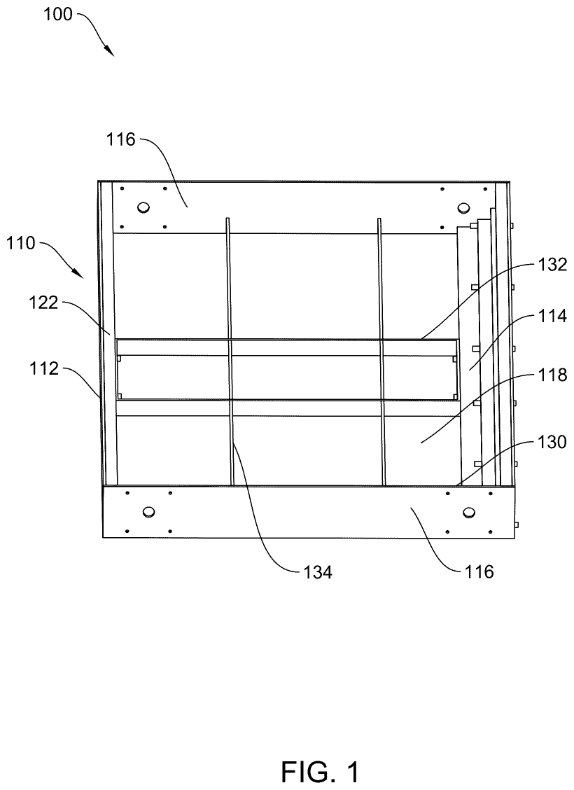

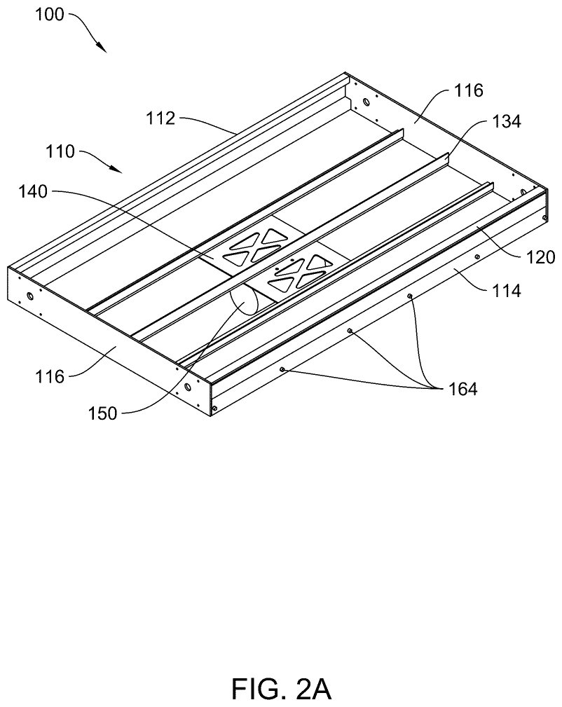

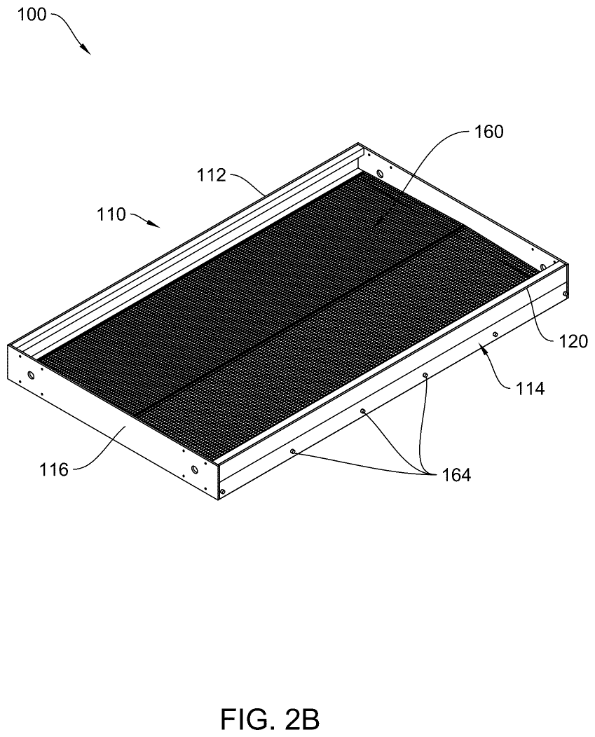

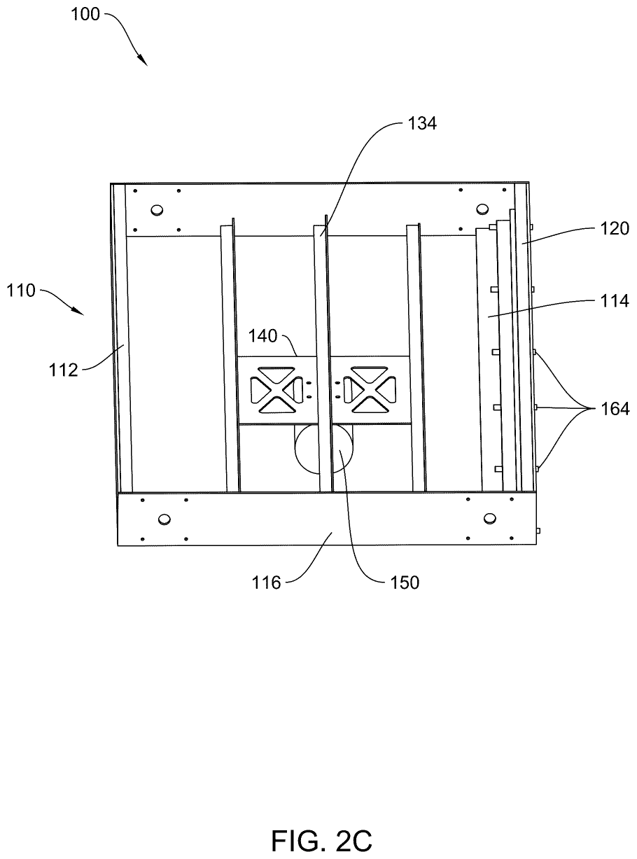

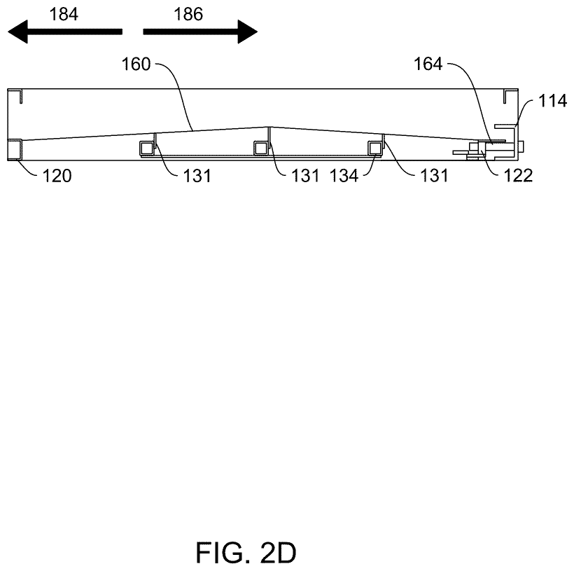

With reference to FIGS. 1 and 2A-2D, a screen system 100 includes an external frame 110, a screen 160 and a vibration device 150. The external frame 110 provides support for the system 100 and includes a first wall 112, a second and opposite wall 114, and, optionally, side walls 116, defining an opening 118 through which proppant passes during operation of the screen system 100. One or more internal support structures 132 and 134 extend across the opening 118. In some embodiments, the internal support structures 132 and 134 cross with other support structures, as it illustrated in FIG. 1. In some embodiments, the internal support structures 132 and 134 are configured as internal support beams that extend across at least a portion of the opening 118 of the external frame 110. First and second screen mounts 120 and 122 are disposed within the opening 118, and are preferably located at opposite sides of the external frame 110. In the embodiment shown in FIGS. 1 and 2, the one or more internal support structures 132 and 134 are coupled to the first and second screen mounts 120 and 122, respectively, forming an internal frame 130.

In the embodiment shown in FIGS. 1 and 2A-2D, the external frame 110 optionally includes additional side walls 116 for support. The one or more internal support structures 132 and 134 are connected to at least one of the first wall 112, the second wall 114, or the additional walls 116, and provide additional strength to the frame during operation to resist bending, bowing, or other deformation of the screen system 100 during use.

With specific reference to FIGS. 2B and 2D, the one or more internal support structures 134 also support the screen 160 during operation to prevent the screen 160 from tearing during use of the screen system 100. The screen 160 extends across at least a portion of the opening 118 defined by the external frame 110, resting either directly or indirectly on the internal support structures 134. Although specific reference is made to the embodiment illustrated in FIGS. 2A-2D, it should be understood that the embodiment illustrated in FIG. 1 wherein there are multiple crossing support structures 132 and 134, also accommodates a screen. The support structures 132 and/or 134 may optionally include risers 131 that extend from the support structures 132 and/or 134 to engage the screen 160. In some configurations, the support structures 132 and/or 134 and the risers 131 support the screen 160 in a flat configuration. In a flat configuration, any contaminants or debris caught by the screen 160 will be removed from the screen 160 surface by the vibrations of the screen 160 and forces provided by the flow of the proppant. In other configurations, the support structure and accompanying risers support portions of the screen 160 at a first elevation such that the screen is in a sloped configuration such that at least a portion of the screen 160 presents an angled surface relative to the opening 118 defined by the external frame 110 or with respect to the bottom of the external frame. In some embodiments, the entire surface of the screen 160 is sloped at a single angle. In other embodiments, the internal support structures 132 and/or 134 may support portions of the screen at more than one elevation, i.e., one portion held at a first elevation and a second portion held at a second elevation, relative to the external frame. In the embodiment illustrated in FIGS. 2B and 2D, the screen 160 extends and/or is otherwise pulled across the internal support structures 134 such that a first portion of the screen 160 surface is provided at a first angle and a second portion of the screen 160 surface is provided at a second angle. The angle of the screen 160 surface provides a fulcrum for tightening the screen 160 using the screen tension adjustment portion 164, described in more detail below. The angle of the screen 160 surface also assists contaminants caught by the screen 160 to fall out of the screen system 100. The support structures of FIG. 1 132 and/or 134 may function to support a screen in similar manner.

Due to the erosive nature of the proppant flow, the screen 160 can be made of a strong material with high durability. In one embodiment, the screen 160 is metal wirecloth. According to some embodiments, the screen 160 is made of metal, such as carbon steel, stainless steel, steel alloy, galvanized steel, or spring steel. Alternatively, the screen 160 may be made of tungsten alloys, titanium alloy, nickel-based alloy, aluminum alloy, copper alloy, magnesium alloy, or a mixture of alloys. If heating of the screen 160 is not desired (described in more detail below), non-metal materials may also be used. In these situations, a high-durability material is recommended. For example, in some embodiments, the screen 160 may be made of nylon, acetal (polyoxymethylene, polyetheretherketone (peek), polyvinylchloride (PVC), polyurethane, Kevlar, carbon fiber, high-density polyethylene, or ultra-high molecular weight polyethylene, or any other high-durability material as known in the art. The screen 160 may be made of a single material or a combination of these materials. In some embodiments, the screen 160 is coated with a second material to enhance the durability or performance of the screen 160.

Alternatively, the screen 160 may be a sieve. In some embodiments, the screen 160 may be a perforated sheet with holes punched through the sheet such that the holes permit proppant to pass through the sheet. It should be understood, however, that the sheet or sieve configuration provides additional durability at the cost of a lower overall open area and potentially with greater weight, compared to the screen 160 configuration.

The screen 160 has openings sized to permit proppant particles to pass through the mesh while retaining contaminants in the proppant, such as stones or aggregate. The screen 160 may a size from about 60 mesh to about 18 mesh. The screen 160 may have an opening size from about 250 microns to about 1 centimeter, depending on the size of proppant particles to be cleaned. Larger holes will allow more efficient passing of the proppant through the screen 160, but at an increased risk of contaminant slipping through the screen 160. Conversely, smaller holes will increase the amount of contaminant rejected by the screen 160 as the proppant flows through, but may result in an overall lower flow rate of proppant into the blender.

The holes of the screen 160 may be of any desired shape, so long as they provide sufficient interference to the contaminants in the proppant flow. For example, the holes may be square, square with rounded corners, rectangular, rectangular with rounded corners, circular, round, elliptical, triangular, pentagonal, hexagonal, or stadium-shaped.

The screen 160 is stretched across the opening 118 defined by the external frame 110, with one side of the screen 160 coupled to the first screen mount 120 and another side of the screen 160 one coupled with the second screen mount 122. The screen 160 includes means for coupling to the screen mounts 120 and 122. In an embodiment, the screen 160 has hooks that engage with a portion of the screen mounts 120 and 122. The hooks may engage with the sides of the screen mounts 120 122, or the screen mounts 120 may have openings, slots, or another engagement feature to engage the hooks of the screen 160.

The screen system 100 includes at least one screen tension adjustment portion 164 (FIGS. 2A-2D), allowing the tension of the screen 160 to be adjusted. The screen 160 can be considered to have a first side or end, and second side or end. In some embodiments, the first end of the screen is coupled to a screen tension adjustment portion while the second end is anchored to the frame. In other embodiments, both ends are coupled to tension adjustment portions 164, allowing adjustment of the screen tension from either end of the screen. In some embodiments, the screen ends 160 are permanently coupled to the tension adjustment portions 164. In other embodiments, the screen ends are detachably coupled to the tension adjustment portions 164. In some embodiments, the screen ends are coupled to the tension adjustment portion via at least one of a hook, a clasp, a screw, a bolt, a pin, or an adhesive. In some embodiments, the screen end forms at least a portion of the hook or clasp to couple to the tension adjustment portion.

In the embodiment illustrated in FIGS. 2A-2D, the tension adjustment portion 164 may be a screw that engages with the wall 114 of the external frame 110 and with a screen mount 122. By turning the screw, the position of the screen mount 122 relative to the wall 114 of the external frame 110 can be adjusted in the direction of arrows 184 or 186, resulting in the tension of the screen 160 being increased or decreased.

As shown in FIGS. 2A-2D, the external frame 110 includes a mount 140 for the vibration device 150. The vibration device mount 140 is coupled to at least one of the internal supports 132 and/or 134. The vibration device mount 140 is shown in the embodiments of FIGS. 2A-2D to be centrally located, but the mount 140 may also be positioned off-center or close to one side of the screen 160 as needed. A vibration device 150 is mounted to the vibration device mount 140, and during operation the vibration device 150 transfers vibrating motions to the frame. In operation, the vibrations assist the proppant to pass through the screen 160 into the blender.

The vibration device 150 may be any device capable of providing sufficient vibration to the screen 160. For example, in some embodiments, the vibration device 150 is an eccentric rotating mass (ERM) motor. In other embodiments, the vibration device 150 is a linear resonance actuator (LRA). The operation of the vibrating device is preferably adjustable so that the amplitude and frequency of the vibrations transmitted to the screen 160 may be adjusted.

In some embodiments, portions of the screen system 100 are isolated from the vibration provided by the vibration device 150. To reduce mechanical stress on the external frame 110, in some embodiments portions of the external frame 110 are isolated from the vibrations of the vibration device 150 by an isolation layer. In some embodiments, the isolation layer is a layer positioned between the isolated parts and is formed of rubber, foam, an elastomer, cork, or a laminate material. In other embodiments, the isolation layer is provided by springs, pneumatic devices, or mass dampeners. For example, in some embodiments, a rubber isolation layer is positioned between the first wall 112 and the internal support structures 132 and/or 134 and between the second wall 114 and the internal support structures 132 and/or 134. In some embodiments, a rubber isolation layer is positioned between the additional walls 116 of the external frame 110 and the internal frame provided by the internal supports 132 and/or 134. In this way, the vibrations provided by the vibration device 150 can be isolated to the vibration device mount 140, the internal support structures 132 and 134, and the screen 160.

In some embodiments, the screen 160 of the screen system 100 may be heated. According to some embodiments, the screen system 100 includes electrical connections to at least a portion of the screen 160. Electricity can be provided to the screen 160 through the electrical connections, causing at least a portion of the screen 160 to heat. Heating the screen 160 can facilitate the processing of wet proppant, such as wet sand. In particular, wet proppant, such as wet sand, is cohesive and adhesive, causing it to clump together and to also stick to the screen 160. This reduces the flow rate of proppant that can be processed through the screen 160. By heating the screen 160, a portion of the water in the proppant that contacts the screen 160 material evaporates, reducing or even eliminating the cohesive and adhesive effects and thereby permitting higher flow rates of proppant to pass through the screen 160 into the blender.

The external frame 110, according to the embodiment shown in the figures, may be rectangular. However, it should be understood that the external frame 110 may be of any desired shape. The external frame 110 may be sized and shaped appropriate to the blender inlet. The external frame 110 may cover the entire blender inlet or only a portion thereof. In situations where the blender inlet is larger than the external frame 110 of a screen 160, multiple screens may be used to provide coverage of the entire blender inlet.

Returning to the discussion of the external frame 110, the shape of the external frame 110 may be any desired shape, so long as the frame provides support for the other parts of the screen system 100. The external from may have straight walls, as shown in the embodiment, or it may have curved walls, or it may have walls that have straight and curved portions. For example, the external frame 110 may be rectangular, square, circular, elliptical, pill shaped, stadium shaped, or ovular. Corners on the frame may be sharp or rounded as needed. In the case that the external frame 110 is round, one portion of the external from may be considered to form the first wall 112 and a second portion of the external frame 110 may be considered to form the second wall 114. For example, in the case that the frame is circular, two opposing semi-circular walls are considered to comprise the first wall 112 and second wall 114 to form the external frame 110.

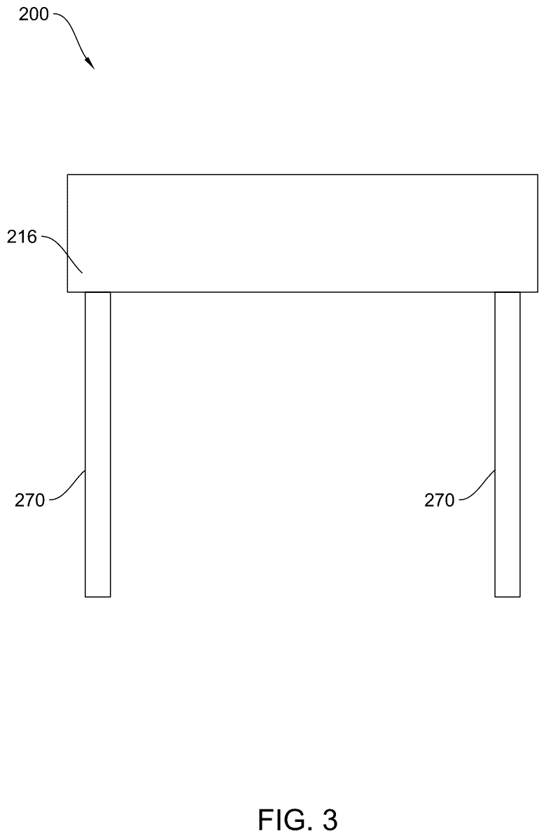

Referring to FIG. 3, in some embodiments, a screen system 200 includes other supports to maintain the external frame 210 in a desired position. For example, in some embodiments, the screen system 200 includes one or more legs 270 extending from the external frame 210. The screen system 200 may include legs 270 that are adjustable length such that the height of different portions of the external frame 210 may be adjusted. In some embodiments, the legs 270 are configured to engage with the ground, floor, a footer, a foot member, or a concrete pad. In some embodiments, the legs 270 are configured to engage with a portion of the blender or the blender inlet. In some embodiments, the legs 270 connect to a main support frame which in turn supports the external frame 210 of the screen system 100. In other embodiments, the legs 270 directly support the external frame 210. In other embodiments, the legs 270 are indirectly coupled to the external frame 210 and have rubber or other vibration-absorbing or vibration-isolating material in between the supports and the external frame 210.

The systems disclosed herein may be employed to clean and process proppant flow into a blender at high throughput rates. The systems disclosed can be safely used with, for example, uncleaned mining product, such as sand that contains contaminants such as stone, rock, or aggregates. The systems described are able to remove the contaminants from the proppant as the proppant is fed to the blender.

In one embodiment, the proppant stream fed to the screen system 100 200 may include proppant and contaminants, such as natural debris, rocks, stones, or aggregates. The proppant stream may be wet or dry. In some embodiments, the proppant stream is not cleaned before being fed to the screen system 100 200. In some embodiments, the proppant stream is unsorted or loosely sorted mining residue, such as sand, and contains a substantial amount of contaminants by weight. In some embodiments, the proppant stream as fed to the screen system 100 200 includes more than 5 wt. % contaminants. In some embodiments, the proppant stream includes 10 wt. %, 15 wt. %, 20 wt. %, 25 wt. %, 30 wt. %, 35 wt. %, 40 wt. %, 45 wt. %, or 50 wt. % contaminants when fed to the screen system 100. In some embodiments, the proppant stream includes more than 2 wt. % water when fed to the screen system 100. In some embodiments, the proppant stream includes more than 5 wt. %, 10 wt. %, 15 wt. %, 20 wt. %, 25 wt. %, 30 wt. %, 35 wt. %, 40 wt. %, 45 wt. %, or 50 wt. % water when fed to the screen system 100 200. In some embodiments, the proppant stream is a slurry. In some embodiments, the proppant stream includes other chemicals, such as surfactants, that will make up the final frac fluid.

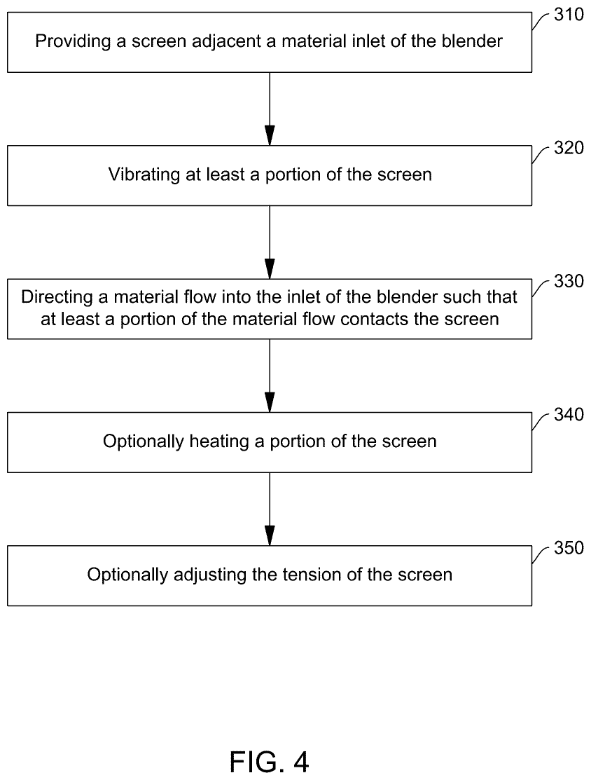

Referring now to FIGS. 2A-2D, 3, and 4, a method of cleaning proppant is also disclosed herein. In some embodiments, the method includes a step 310 of placing a screen system 100 adjacent to the material inlet of a frac blender. In other embodiments, the screen system 100 is placed on or in contact with at least a portion of the inlet to the frac blender. In other embodiments, a screen system 100 is placed adjacent a hopper or other collection space suitable for collecting cleaned proppant. Material that passes through the screen is directed into the inlet of the frac inlet blender.

Before operation of the screen system 100, the screen 160 may be tightened into position within the screen system 100. Tightening the screen 160 permits the screen 160 to provide a stable surface for the proppant stream to pass through. If the screen 160 becomes loose within the screen system 100, it will reduce the effectiveness of the screen system 100 to remove debris and may reduce the overall throughput of the screen system 100. The screen 160 may also periodically require tightening during operation of the screen system 100.

Once the screen system 100 is positioned, another step 320 includes starting a vibration source on the screen system 100, which is operable to provide vibration to at least a portion of the screen system 100, with focus on the screen 160 itself. In another step 330, a proppant stream is fed to the screen system 100. The vibrations enhance the flow of the proppant through the holes provided by the screen 160, increasing the flowrate of the proppant into the blender inlet. The frequency and amplitude of the vibrations provided to the screen 160 can be adjusted to optimize the amount of proppant stream cleaned by the system.

The screen system 100 may be supported by legs 170 or other support members to maintain the position of the screen 160 before the blender inlet. The legs 170 may be supported by the ground, a concreate pad, or by the blender itself.

In one embodiment, the proppant stream fed to the screen system 100 may include proppant and contaminants, such as natural debris, rocks, stones, or aggregates. The proppant stream may be wet or dry. In some embodiments, the proppant stream is not cleaned before being fed to the screen system 100. In some embodiments, the proppant stream is unsorted or loosely sorted mining residue, such as sand, and contains a substantial amount of contaminants by weight. In some embodiments, the proppant stream as fed to the screen system 100 includes more than 5 wt. % contaminants. In some embodiments, the proppant stream is wetted before it is fed to the blender screen. In some embodiments, the proppant stream includes 10 wt. %, 15 wt. %, 20 wt. %, 25 wt. %, 30 wt. %, 35 wt. %, 40 wt. %, 45 wt. %, or 50 wt. % contaminants when fed to the screen system 100. In some embodiments, the proppant stream includes more than 2 wt. % water when fed to the screen system 100. In some embodiments, the proppant stream includes more than 5 wt. %, 10 wt. %, 15 wt. %, 20 wt. %, 25 wt. %, 30 wt. %, 35 wt. %, 40 wt. %, 45 wt. %, or 50 wt. % water when fed to the screen system 100. In some embodiments, the proppant stream is a slurry. In some embodiments, the proppant stream includes other chemicals, such as surfactants, that will make up the final frac fluid.

In some optional embodiments, in another step 340 portions of the screen system 100 is heated. In an example, the method includes providing electrical current to at least a portion of the screen 160 such that the screen 160 material is heated. In some embodiments, the amount of electrical current to the screen 160 is adjustable to maintain a desired flow of proppant into the blender inlet. The screen 160 is heated to maintain the screen 160 material at or about 100° C. or to a higher temperature. In this way, the screen 160 will cause moisture contained in the proppant stream to evaporate.

In some optional embodiments, another step 350 includes adjusting the tension of the screen during operation of the device. For example, tension adjustment mechanism may be tightened or otherwise adjusted to increase the tension in the screen material, pulling it more tightly across the supports. This action may reduce or prevent the screen from sagging during use and increase the overall effectiveness of the screen by reducing the incidence of debris becoming deposited in a depression in the screen.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right “, “front” and “rear”, “above” and “below” and the like are used as words of convenience to provide reference points and are not to be construed as limiting terms. As used herein, “longitudinal” is intended to mean along a longer axis and “transverse” is intended to mean perpendicular to longitudinal.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

Furthermore, invention(s) have been described in connection with what are presently considered to be the most practical and preferred embodiments and it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A blender screen system comprising:
a screen frame comprising:
an external frame having a first wall and an opposite second wall,
an internal support beam extending from the first wall to the second wall;
a first screen mount;
a second screen mount; and
a vibration device mount;
a vibration device coupled with the vibration device mount; and
a screen having a first end and a second opposite end, wherein the first end of the screen is detachably coupled to the first screen mount and the second end of the screen is detachably coupled to the second screen mount,
wherein the first screen mount includes a tension adjustment portion configured to adjust the tension of the screen.

2. The blender screen system of claim 1, wherein the external screen frame further comprises at least one support member extending from the external frame.

3. The blender screen system of claim 2, wherein the at least one support member is configured to engage with at least one of a ground, a floor, a footer, a foot member, or a portion of the blender.

4. The blender screen system of claim 1, wherein the screen frame further comprises a second internal support beam extending from the first wall to the second wall.

5. The blender screen system of claim 4, wherein the first internal support beam supports the screen at a first elevation relative to a bottom surface of the screen frame and the second internal support beam supports the screen at a second elevation relative to the bottom surface of the screen frame, such that at least a portion of the screen is angled with respect to the bottom surface of the screen frame.

6. The blender screen system of claim 1, wherein the first end of the screen is detachably coupled to the first screen mount by at least one of a hook, a clasp, a screw, a bolt, a pin, or an adhesive.

7. The blender screen system of claim 1, wherein the first screen mount comprises hooks configured to engage with a portion of the screen.

8. The blender screen system of claim 1, wherein the screen comprises hooks configured to engage with at least one of the first screen mount and with the second screen mount.

9. The blender screen system of claim 1, wherein the vibration device is a vibrating motor.

10. The blender screen system of claim 9, wherein the vibrating motor is adjustable to produce a desired amplitude and frequency of vibration.

11. A method providing material to a blender, the method comprising:
providing a screen adjacent a material inlet of the blender;
vibrating at least a portion of the screen; and
directing a material flow into the inlet of the blender such that at least a portion of the material flow contacts the screen.

12. The method of claim 11, further comprising heating at least a portion of the screen.

13. The method of claim 11, further comprising adjusting a tension of the screen.

14. The method of claim 11, wherein the material is a wet sand.

15. The method of claim 11, wherein vibrating at least a portion of the screen comprises operating a vibrating motor coupled to the screen.

16. The method of claim 11, further comprising wetting the material flow prior to directing the material flow into the inlet of the blender.
